(19) United States
(12) Patent Application Publication
(10) Pub. No.: US 2012/0331410 A1
(43) Pub. Date: Dec. 27, 2012

(54) METHODS AND SYSTEMS FOR DESIGNING IT SERVICES

(75) Inventors: Lars Hagen, Mering (DE); Hubert Voth, Kleinaitingen (DE); Laia Subira, Munchen (DE)

(73) Assignee: Fujitsu Technology Solutions Intellectual Property GmbH, Munchen (DE)

(21) Appl. No.: 13/169,557

(22) Filed: Jun. 27, 2011

(51) Int. Cl. G06F 3/048

(52) U.S. Cl. 715/763

(57) ABSTRACT

At least one service product to be provided by a designed IT service is selected using a graphical user interface. Mandatory service elements required for the at least one service product are added automatically and displayed. A configuration of the designed IT service is output.

### TECHNICAL FIELD

This disclosure relates to the field of information technology (IT). More particular, the disclosure relates to methods and systems for designing IT services.

### BACKGROUND

In today's environment, more and more business functions depend on the provision and operation of reliable IT services. Such functions include, but are not limited to, accounting, invoicing, logistics, technical information, electronic communication such as e-mail and web services, and many others. Therefore, to a large extent, the success of a particular business often depends on the successful implementation of its IT services. At the same time, businesses are trying to focus on their core competences as well as saving cost. Therefore, designing and operation of IT services is often outsourced to IT service specialist companies, in particular in small and medium enterprises (SME). Alternatively, especially in large enterprises, designing and operation of IT services is often organized in a specialized IT department, which is operated more or less independently from the rest of the organization.

External IT service providers and internal IT departments alike are therefore faced with the challenge of providing reliable IT services at a competitive price. To meet the level of reliability required, a number of good-practice methods for designing and implementing IT services have been devised. One example of such a collection of good practices is the so-called “IT infrastructure library” (ITIL) managed by the Office of Government Commerce (OGC) of the United Kingdom. Currently, ITIL Version 3 is used by many IT service providers.

In addition to general practices and guidelines as provided by the ITIL and similar standards, a number of service provider-specific information needs to be considered when designing IT services. For example, an IT service provider having a contractual link with a provider of IT hardware or software should preferably offer IT services that are based on or can be implemented in combination with the respective hardware or software of the associated partner. Even more importantly, customer specific request need to be considered. Moreover, any new IT service provided should integrate with the IT services of a customer.

Since both the IT services offered as well as the hardware and software used to implement them becomes more and more complex, the process of designing and providing IT services becomes more and more complex as well. In particular, designing an IT service based on the numerous requirements, which are usually in written form in various types of documents, is often frustrating, error prone and time consuming even for a skilled IT service planner. Therefore, there clearly exists a need for methods and systems to improve designing IT services.

### SUMMARY

We thus provide a method for designing IT services. The method comprises selecting, with a graphical user interface, at least one service product to be provided by the designed IT service, adding mandatory service elements for the at least one service product to a configuration of the designed IT service automatically based on a set of service element dependencies stored in a service element database, displaying, with the graphical user interface, a graphical representation of the added mandatory service elements in a service element view, and outputting the configuration of the designed IT service comprising information about the added mandatory service elements.

The method further comprises displaying, with the graphical user interface, optional service elements compatible with the at least one service product and interactively adding, with the graphical user interface, at least one of the displayed optional service elements to the designed IT service by adding it to the service element view. In the step of outputting, information about the at least one added optional service element is included in the configuration of the designed IT service.

An IT service design system is also provided. The system comprises a display means for displaying a graphical user interface, storage means for storing a service element database comprising a set of service element dependencies and processing means for processing a method for designing IT services.

A computer-readable storage medium comprising program code adapted to perform a method for designing IT services is further provided. When the program code is executed by a processing unit of a computing device, the method performs the following steps:
selecting, with a graphical user interface, at least one service product to be provided by the designed IT service;
adding mandatory service elements for the at least one service product to a configuration of the designed IT service automatically based on a set of service element dependencies stored in a service element database;
displaying, using the graphical user interface, a graphical representation of the added mandatory service elements in a service element view; and
outputting the configuration of the designed IT service comprising information about the added mandatory service elements.

It has been found that by providing a graphical user interface to display and optionally modify service elements of a designed IT service, the process of designing IT services can be greatly enhanced. Furthermore, by providing a service element database comprising service element dependencies, configuration rules used for designing and operating the IT service can be automatically implemented in the designed IT service. The provided methods and assistance take these and other facts into consideration to provide more efficient, reliable and easy to use methods and tools for designing IT services.

### BRIEF DESCRIPTION OF THE DRAWINGS

Various methods and systems will be described with reference to the drawings attached.

FIG. 1 shows a flow chart of a method for designing an IT service.

FIG. 2 shows a schematic diagram of a system for designing an IT service.

FIG. 3 shows a view of a user interface for selecting a service product to be provided.

FIG. 4 shows a view of a user interface for displaying and adding service elements.

FIG. 5 shows a view of a user interface for modifying service elements.

FIG. 6 shows another view of the user interface for modifying service elements.

FIG. 7 shows another view of the user interface for modifying service elements.

FIG. 8 shows a view for selecting tools to implement different service elements.

FIG. 9 shows another view for selecting tools to implement different service elements.

FIG. 10 shows a solution overview as output by a tool for designing IT services.

FIG. 11 shows a delivery structure as output by the tool for designing IT services.

FIG. 12 shows a topology as output by the tool for designing IT services.

FIG. 13 shows a rules and skills as output by the tool for designing IT services.

### DETAILED DESCRIPTION

It will be appreciated that the following description is intended to refer to specific examples of structure selected for illustration in the drawings and is not intended to define or limit the disclosure, other than in the appended claims.

In the following, various methods and systems are described with respect to an exemplary software implementation of a tool for designing IT services.

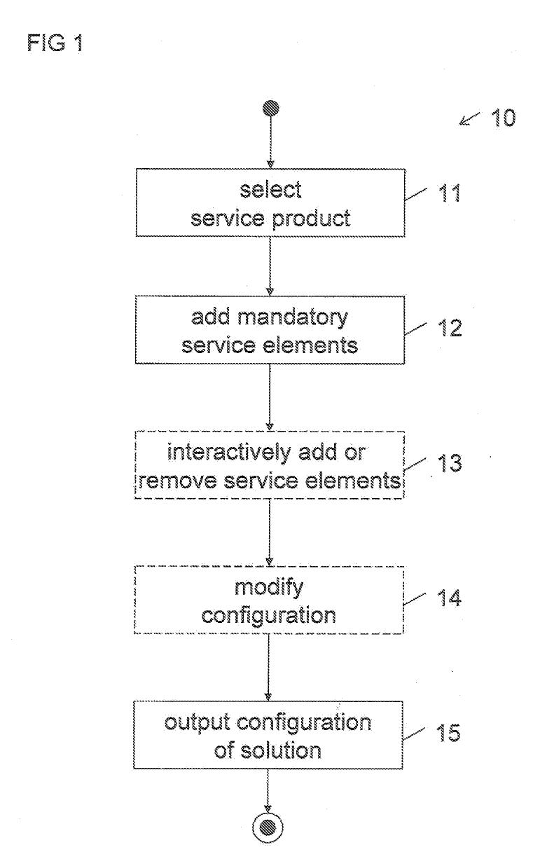

FIG. 1 shows the principal steps of a selected method for designing IT services. In a first step 11, a service product to be provided is selected. A service product in this context may be any IT service to be provided in the designed solution. Examples of services include managed workplaces for some or all employees of a company, i.e., a combination of hardware and software used by the employees to perform their business function, a managed server platform, such as the provision and operation of a web server or a similar service used or provided by a company, a managed backup service such as a service provided to back up all business critical data of a company at regular intervals, and others. Preferably, one of a plurality of service products available by the IT service provider is selected from a list or by a similar selection method with a graphical user interface of an IT service design tool.

In a subsequent step 12, mandatory service elements are added to a configuration for the designed IT service. Preferably, the mandatory service elements are automatically selected and displayed together with their logical dependencies by the graphical user interface. Service elements represent the best-sized unit identified to standardize service delivery of the required IT service. Which service elements are mandatory will typically depend on the previously selected service product. Exemplary mandatory service elements used for the implementation of a managed workplace include an incident management, which allows a user of the managed workplace to report incidents related to the operation of the managed workplace, and a patch management used to update installed software at the managed workplace by an administrator. The exact nature and number of mandatory service elements required to implement a particular service product are defined based on a number of service element dependencies preferably stored in a service element database. For example, based on good practice and previous experience, senior IT service planners may create service element dependency rules and put them in a central service element database, which is in turn accessed by the service design tool.

In a further optional step 13, the operator of the tool for designing IT services may add or remove service elements. For example, optional service elements not needed to implement the designed IT services may be provided to enhance the designed IT services. As another example, some of the mandatory service elements may be removed from a configuration, in case corresponding service elements already exist in the IT service solution of the customer and may be used instead of the default service element. Alternatively, one or more service elements may by highlighted as so-called “placeholders,” which represent service elements provided by the customer and are therefore not part of the delivered service of a service provider.

In practice, optional service elements may be added in response to specific customer requirements. For example, the managed workplace described above may be enhanced by providing a capacity monitoring element. Capacity monitoring allows detecting potential performance bottlenecks before they seriously impact the operation of the managed workplace. For example, capacity problems of a managed data network, a managed data storage facility, or a processing facility of a managed workplace may be detected.

In a free configuration mode, arbitrary service elements from the service element database may be added to or removed from a designed configuration regardless of whether they are mandatory, optional or unrelated to the designed service product. This free configuration mode may also be entered directly by a user, i.e., without selection of one of the pre-defined service-products and without automatic addition of mandatory service elements.

In a further optional step 14, configuration of the designed IT service may be modified. All service elements may come with a default configuration that suffices to implement the designed IT service. Therefore, no further modification may be required in step 14. However, modification of at least some of the service elements may be needed to satisfy specific wishes of a customer. For example, different tools available to implement a given service element may be selected from a list of available tools. In addition, detailed requirements for delivering a specific service element may be provided.

In a step 15, the configuration of the designed IT service is output. Preferably, the output configuration describes the designed IT service in various levels of detail. For example, a high level view of the designed solution can be given in a graphical representation to present the designed IT service to a customer. Furthermore, detailed written documentation providing details of selected service elements, the tools used to implement them as well as further information captured in step 14 may be output. Such detailed information may also be used as a base for a contract between the IT service provider and its customer.

Although the method shown in FIG. 1 is represented as a linear process, in different configurations, the user may step back to a previous stage or jump to any particular step using appropriate control elements. For example, the user may start with the selection of a service product in step 11 and the subsequent automatic addition of obligatory service elements in step 12, subsequently configure these in step 14 in detail and then jump back to add further optional service elements in step 13. Furthermore, the step of displaying may be performed at any stage to show a current configuration even if further additions or modifications are still to be applied.

The process described with respect to the flow chart of FIG. 1 results in a guided process which helps personnel with limited experienced in designing IT services to devise a solution which fulfills the needs of a customer and is compatible with the products and tools available to the IT service provider. It minimizes the risk of designing an IT service which will be either not fully functional or relatively expensive to implement for the IT service provider. Thus, the described method helps the IT service planner to avoid potential contractual or economic penalties. At the same time, the IT service planner as well as the customer is provided with an easy to understand representation of the designed IT service using the graphical interface.

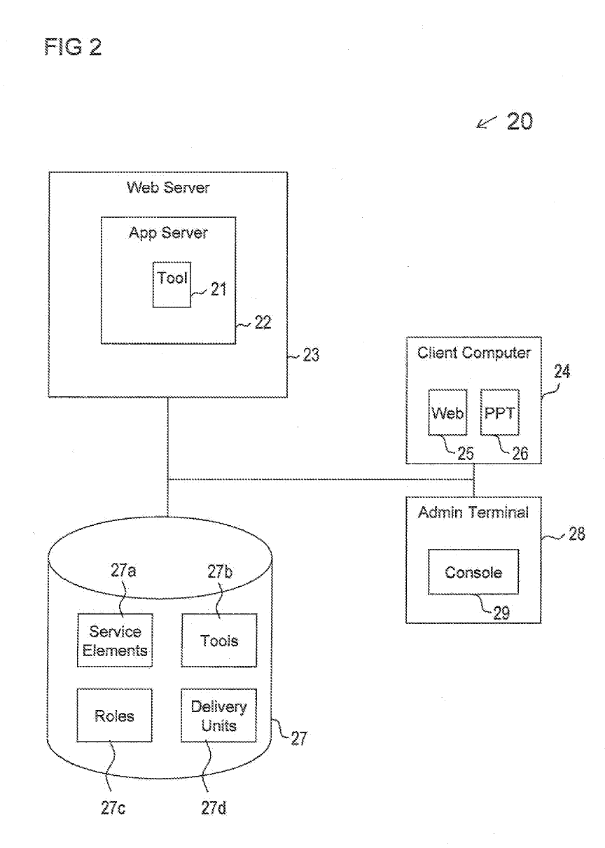

FIG. 2 shows a schematic diagram of a system 20 for designing IT services. The system comprises a computer-implemented design tool 21. The tool 21 was implemented as a portal application to be run by an application server 22 of a web server 23 using the AJAX web programming system. A solution planner may access the web server 23 from a client computer 24 using a web browser 25. The client computer may also addition applications 26, such as Microsoft PowerPoint, for example. Information for the tool 21 is provided by a database server 27. In the depicted example, the database server comprises four database tables storing information about service elements, tools, roles and skills, and delivery units, respectively, corresponding to four logical databases 27a to 27d. The data stored in the databases 27a to 27d may be entered, updated or deleted using a management terminal 28 using a management console application 29. Of course, the data may also be stored in different databases provided by different database servers. Therefore, in the following, the term “database” is used regardless of whether it relates to a logically or physical independent database or merely a table or other forms of information storage provided by a single, central database.

While the system is described in the following with respect to system 20 shown in FIG. 2, other systems and environments for implementation are also envisaged. For example, the described method for designing IT services may also be implemented as an application running on a stand-alone computer or in a client-server environment.

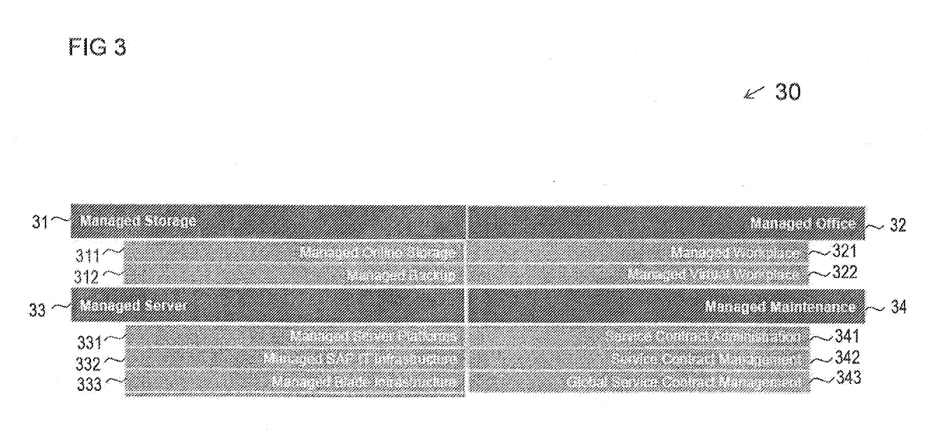

Below, the designing of a concrete IT service using the computer-implemented design tool 21 will be described with reference to the FIGS. 3 to 13 in more detail.

In a first step, the operator of the design system 20 activates the tool 21 for designing IT services. In the described example, the tool 21 is hosted on the application server 22 and accessed using the web-browser 25 of the client computer 24. That is, all data and information are processed and stored by the application server 22 and/or the database server 27, whereas the client computer 24 used by the IT service planner is merely used as an interface to input and output information.

FIG. 3 shows an example of a start screen 30 of the design tool 21. Within the view of FIG. 3, different service products such as Managed Online Storage 311, Managed Workplace 321, Managed Server Platforms 331, and Service Contract Administration 341, are summarized within different service segments, such as Managed Storage 31, Managed Office 32, Managed Server 33, and Managed Maintenance 34. The categorization presented in FIG. 3 has only exemplary character and may be chosen in accordance with the structure of the IT service provider. The available service products may be selected from a list without any added categorization.

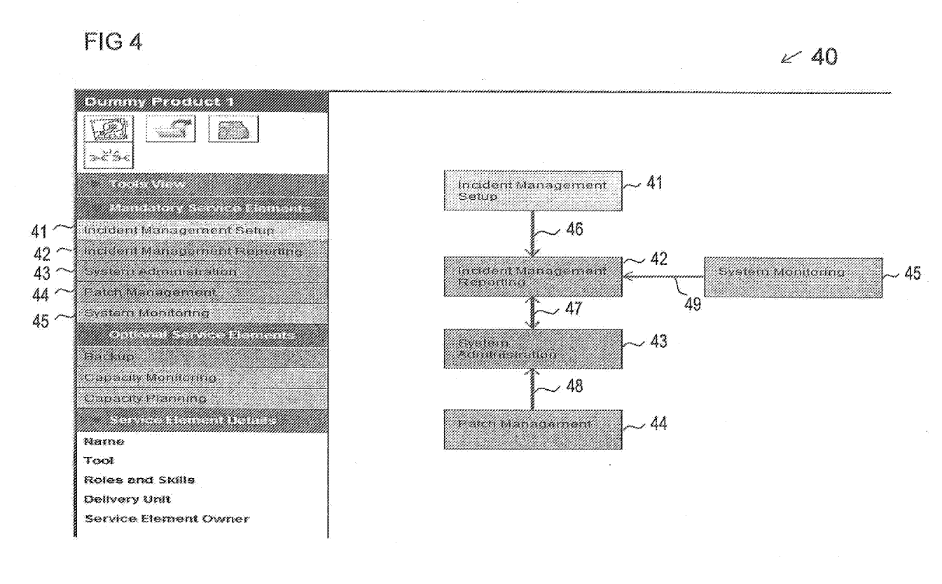

In the described example, the operator of the tool 21 for designing IT services may select the Managed Workplace 321 as the service product to be provided. Based on service element dependencies stored in the service element database 27a, in the following step, a number of mandatory service elements are selected automatically. These are represented in the graphical user interface shown in FIG. 4.

Based on the automatic selection, service elements for incident management setup 41, incident management reporting 42, system administration 43, patch management 44, and system monitoring 45 have been selected and are represented graphically in a mandatory service element view 40 of the design tool 21. For easier comprehension, the different service elements may be divided into different services classes, such as “Transactions” or “User support.” Service elements of different service classes may be represented differently in the service element view 40.

In addition to the service elements themselves, the windowpane in the right hand part of the service element view 40 also graphically shows the relationships between the individual service elements. For example, based on the arrows 46 to 49 between the boxes shown in FIG. 4, it can be determined that the incident management reporting 42 depends on the incident management setup 41, the system monitoring 45 as well as the system administration element 43. Correspondingly, the system administration 43 depends on the incident management reporting 42 and the patch management 45. The graphical display of dependencies between individual service elements helps the solution designer to understand the overall structure of the designed solution.

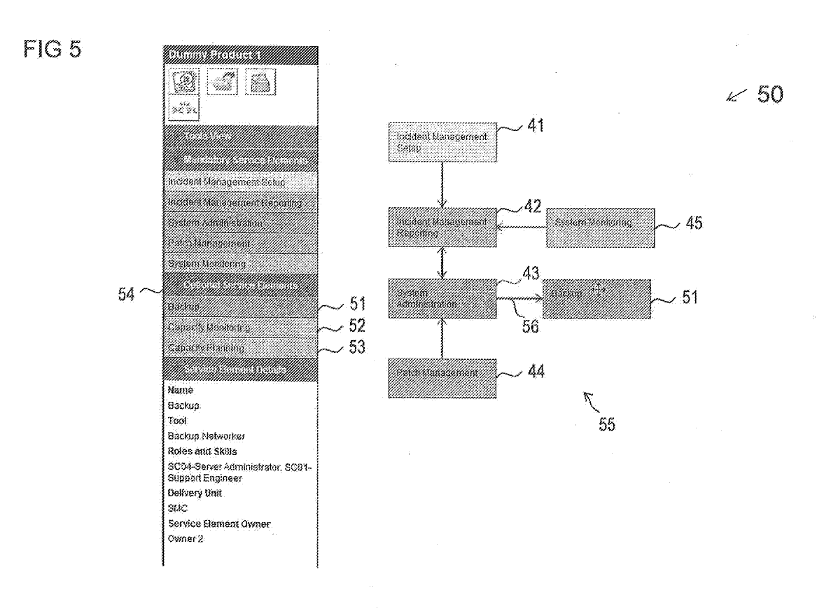

In this or a corresponding view 50, additional service elements may be added interactively by the operator of the design tool 21. This is shown in FIG. 5 where the user has selected an optional backup service element 51 to be included in the designed configuration. Preferably, such optional service elements can be placed in the graphical representation of the currently designed configuration using an intuitive user interface. For example, in the example shown in FIG. 5, the optional backup service element 51 can be selected by the planner with a mouse from the left-hand menu 54 of optional service elements 51 to 53 and dragged into the right-hand pane 55 of the optional service element view 50 using a drag and drop mechanism.

Preferably, the dependency between the added optional service elements and the provided mandatory service elements are automatically updated. In the provided example, the arrow 56 between the mandatory system administration service element 43 and the optional backup service element 51 indicates that the backup service element 51 functionally depends on the availability of the system administration service element 43.

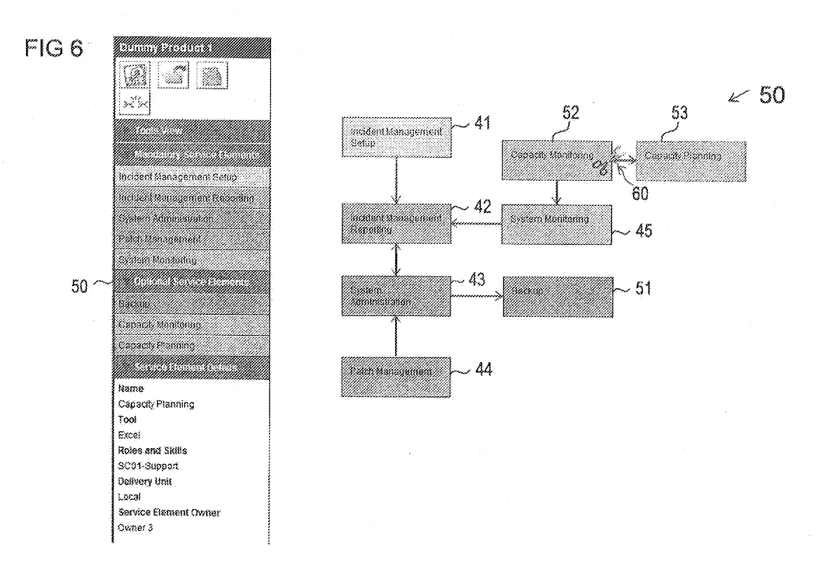

FIG. 6 shows another example of adding an optional service element. In the example shown in FIG. 6, the user of the tool 21 for designing IT services has added the optional service element 52 for capacity monitoring as described above with respect to the optional service element 51. The optional service element 52 for capacity monitoring depends on the optional service element 53 for capacity planning. Therefore, when dragging the service element 52 for capacity monitoring from the optional service element selection menu 54 on the left to the pane 54 on the right of service element view 50, both the capacity monitoring service element 52 as well as the capacity planning service element 53 are added to the designed solution.

The service element view 50 as shown in FIG. 6 also allows removal of both mandatory and optional service elements. However, when trying to remove service elements, preferably, the tool 21 for designing IT services will verify whether the removed service element is either mandatory or required by any other service element which forms part of our solution.

In the described example, the solution planner is trying to delete the automatically added optional service element 53 for capacity planning. In the graphical user interface, this task is achieved with a deletion tool 60, represented in FIG. 6 by a scissor symbol.

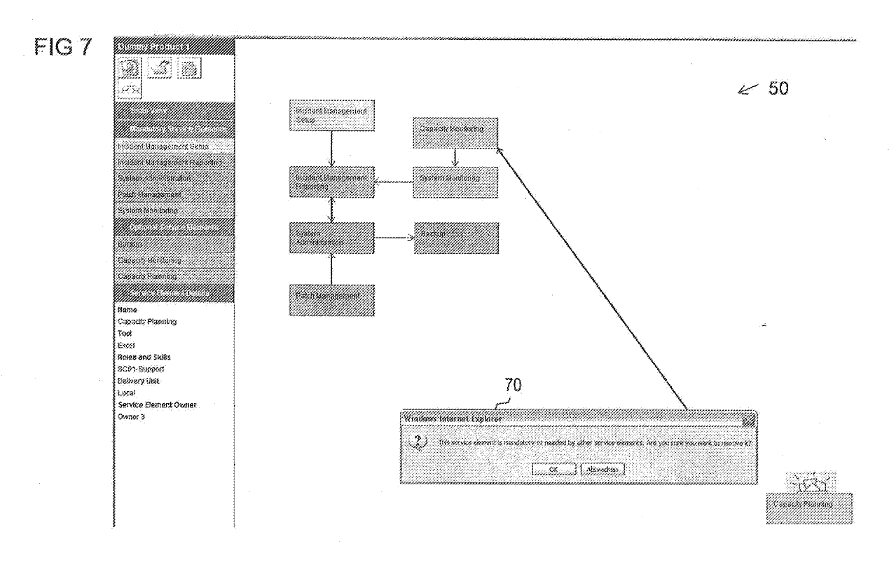

Preferably, upon removal of the capacity planning service element 53, for example, by dragging the service element 53 for capacity planning from the service element pane 55 on the right hand side back to the service element menu 54 on the left or by selecting the service element 53 in the right-hand pane 55 and pressing an appropriate key, such as “Delete,” the application logic of the design tool 21 will check the dependency other service elements included in that configuration with respect to the service element 53. In this particular case, the capacity monitoring service element 52 depends on the capacity planning service element 53. Therefore, when the user tries to delete the capacity planning element 53, a warning message 70 is displayed in the tool for designing IT services. This situation is depicted in FIG. 7.

To give the operator of the tool 21 the possibility to take into account special requirements, such as the requirements formulated by the customer that particular service elements are already provided by the customer itself, in the described emample, the tool 21 for designing IT services will nonetheless allow deletion of a required service element as shown in FIG. 7. In different example, special authorization by a senior solution designer or confirmation by the solution planner may be required:

In general, such a deviation from implementation rules stored in the service element database 27a will result in a solution that deviates from standard solutions and, therefore, result in a higher risk for the IT service company. In one example, a status bar indicating a measure of compliance such as a level of standardization with respect to a preferred standard solution is pro-vided to highlight this risk. For example, a percentage bar showing the level of standardization of the that configuration with respect to a default configuration of a selected service product can be displayed in a separated area of the screen. In addition, the color of the percentage bar can change when predefined thresholds levels are reached. For example, the bar can turn from green into yellow, if a standardization level of less than 70% is reached. Furthermore, the status bar might change to red if a standardization level of less than 50% is reached.

Based on the service elements added automatically or manually to a configuration of the designed IT service, preferably, a number of different views are created with allow the display and further modification of some or all elements of the designed solution. Examples of views for the selection of tools, and output of a delivery structures, roles and skills and topology of the designed solution are described below.

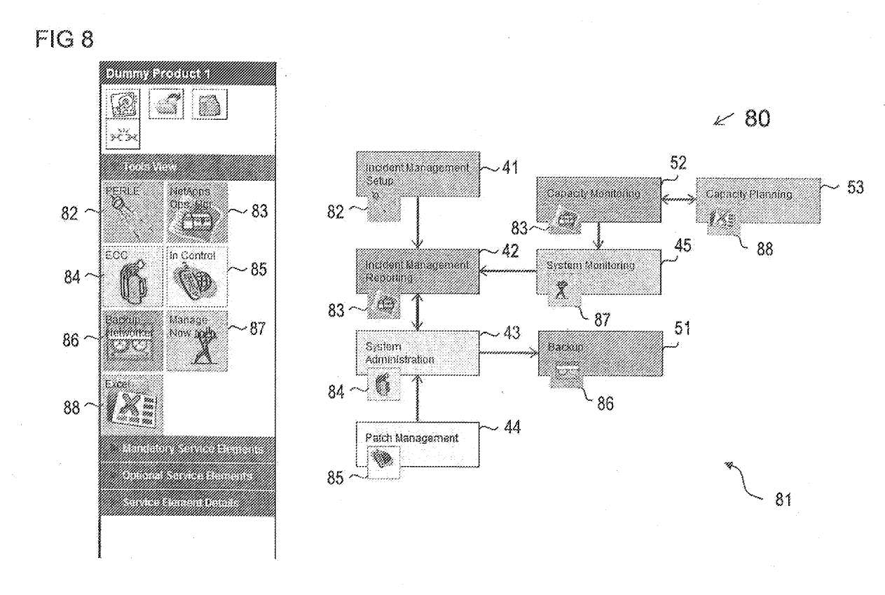

FIG. 8 shows a tool view 80 of the described tool for designing IT services. In the tool view 80 of FIG. 8, for each service element, an icon indicating a tool for the implementation of the respective service element implementation is shown in the right-hand window pane 81. By default, each service element may be assigned to one default tool provided, for example, by the tool database 27b. For example, the incident management setup 41 may be implemented by default using a PERLE tool 82, whereas the capacity monitoring service element 52 is implemented using the NetApps Operations Manager tool 83.

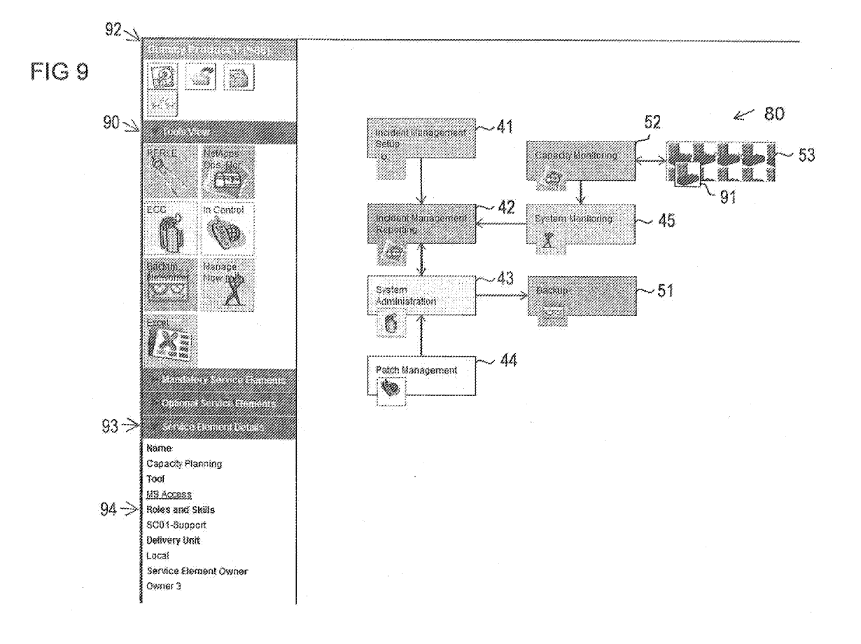

An operator of the tool for designing IT services may change some or all tools used to implement the various service elements in the tool view 80. For example, as shown in FIG. 9, an operator may change the default tool 88 used for capacity planning, in the Microsoft Excel example, to a non-standard tool 91, such as Microsoft Access. For example, one of the tool icons 82 to 88 or 91 may be dragged from a tool menu 90 on the left hand side of the tool view 80 to a service element 53 shown in the window pane 81 on the right. Alternatively, a dialogue guiding the planner through the required steps is provided as part of the design tool 21.

From the view of the upper left hand corner of FIG. 9, one can see a status 92 bar indicating that the level of standard compliance has dropped to 88% as a result of using a non-default tool 91.

Furthermore, it can also be seen that further details of the selected service element 53 are in shown in a service element detail view 93 on the lower left hand part of the graphical user interface. Using the detail view 93, changes can also be applied with respect to the roles and skills required to implement each specific service element. In the depicted view 93, this can be achieved by clicking on the roles and skills section 94 and manually entering the required details. However, in another example, a separate roles and skills view may also be implemented to add, remove and/or modify skills and roles description provided by a respective database 27c.

In a similar fashion, hardware requirements specified by the customer, i.e., the use of server computers of a particular brand or manufacturer, may be captured using this or a similar view of the design tool.

Of course, further requirements may be added, which may or may not be graphically represented by the graphical user interface. For example, unusual customer requests may be noted in a free-text form and will be included in all or some output configuration views in the form of textual notes. Such special requests need to be considered very carefully when determining a guaranteed service level or costing the designed solution.

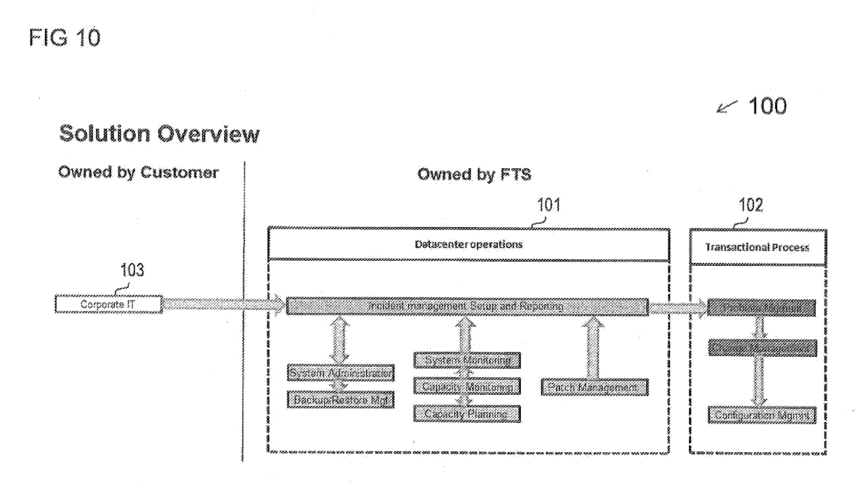

FIGS. 10 to 13 show an example of an output as provided by the described tool for designing IT services once a satisfactory configuration has been designed. They show, in a graphical representation, the kind and organization of the designed solution provided by the IT service provider. Optionally, it may also show organizational details or elements of the customer.

In the high-level solution overview 100 presented in FIG. 10, one can see that to implement the requested IT service two functional blocks for datacenter operations 101 and transactional processes 102 are provided by the IT service provider. Within the datacenter operations 101, incident management setup and reporting is provided which depends on system administration and backup/restore management, system monitoring, capacity monitoring and capacity planning as well as patch management. Furthermore, the transactional processing 102 comprises a service for problem management as well as change management which provide information to a service for configuration management. Information for the incident management setup and reporting service are provided from the corporate IT 103 of the customer.

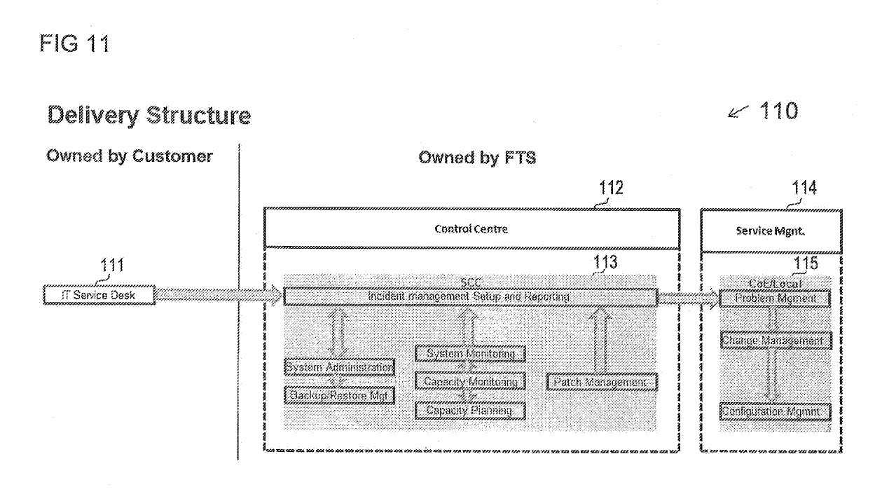

FIG. 11 shows the delivery structure 110 of the solution described above with respect to FIG. 10. In particular, it shows that the information provided by the customer is provided by its IT service desk 111. The incident information is managed by the service control center (SCC) 113 of a control center 112. The transactional processes are delivered by a service management 114 which is based on a local Center of Excellence (CoE) 115.

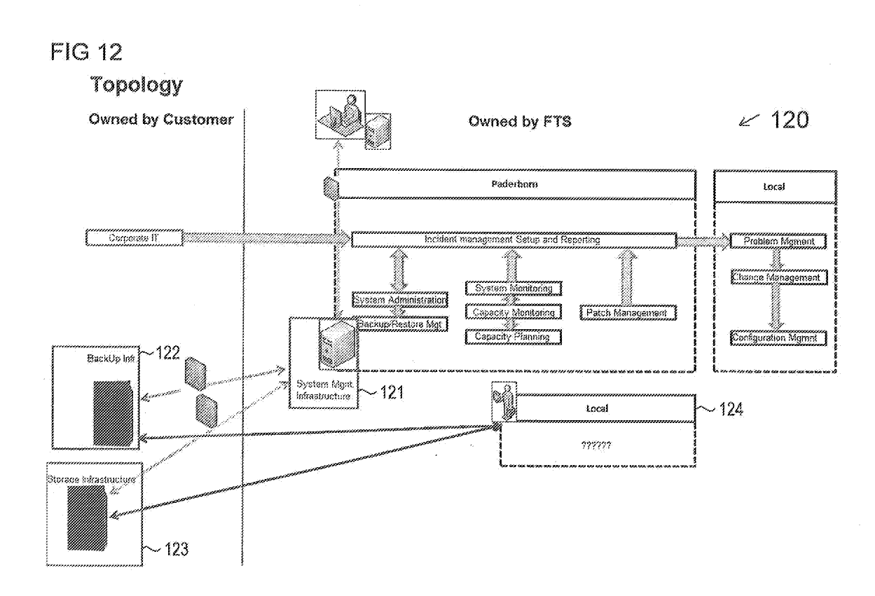

FIG. 12 shows the topology 120 of the solution described with reference to FIGS. 10 and 11. In particular, FIG. 12 shows that the backup/restore management comprises a system management infrastructure 121 provided in a control center 112 of the service provider located in Paderbron, Germany, as well as a backup infrastructure 122 and storage infrastructure 123 provided by the customer. To aid integration of the customer provided backup infrastructure 122 and storage infrastructure 123 to the solution managed by the control center 112 of the IT service provider, a role 124 is defined for a local a database and storage administrator. The local administrator belongs organizationally to the IT service provider but works locally at the site of the customer, i.e., the administrator is not assigned to or located in a central delivery center.

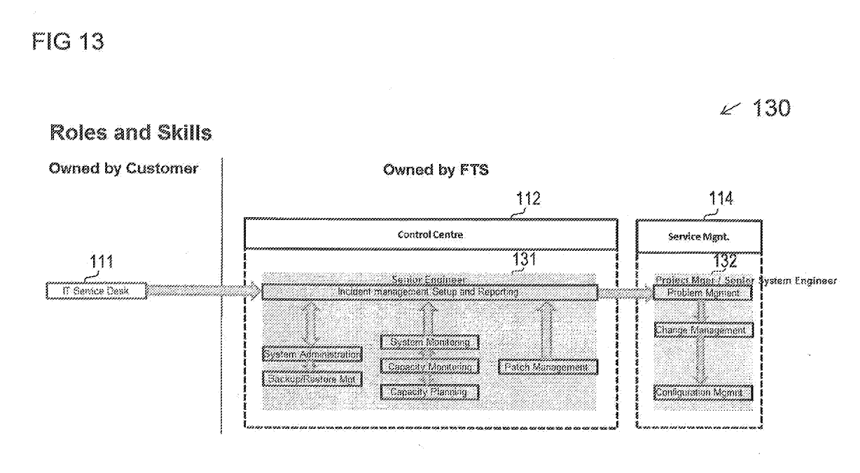

FIG. 13 shows a view 130 of the roles and skills required to implement the solution described above with reference to FIGS. 10 to 12. In particular, FIG. 13 shows that a senior engineer 131 implements the incident management setup and reporting and dependent modules at the control center 112. Furthermore, a project manager 132 or senior system engineer implements the problem management and other components of the service management 114.

The output diagrams 100, 110, 120 and 130 described above with respect to FIGS. 10 to 13 may be exported into another application 26 such as Microsoft PowerPoint, for example, for further customer specific annotation or presentation. For this purpose, an application specific plug-in or an export function of the tool 21 using a general-purpose file format may be used.

Based on the graphical representation of the solution, the IT service solution designer as well as the customer can decide if the current configuration is appropriate for their respective needs. If this is the case, the designed IT service can be implemented based on the provided documentation. Otherwise, the IT service planner can go back to one of the previous views and further modify the solution, for example, by adding or removing service elements or configuring them.

Preferably, to add an enhanced level of documentation and to allow reuse of previously determined configurations, individual configurations and versions thereof can be stored by the tool 21, for example, in a separate database of the database server 27. Furthermore, the tool 21 for designing IT services may provide an interface available over the web browser 25 or a special console 29 for administrators to enter or modify rules such as service element dependencies or service tool availabilities stored in the databases 27a to 27d.

Although the methods and systems have been described in connection with specific forms thereof, it will be appreciated that a wide variety of equivalents may be substituted for the specified elements described herein without departing from the spirit and scope of this disclosure as described in the appended claims.

What is claimed is:

1. A method for designing IT services comprising:
selecting, with a graphical user interface, at least one service product to be provided by a designed IT service;
adding mandatory service elements for the at least one service product to a configuration of the designed IT service automatically based on a set of service element dependencies stored in a service element database;
displaying, with the graphical user interface, graphical representations of the added mandatory service elements in a service element view; and
outputting configuration of the designed IT service comprising information about the added mandatory service elements.

2. The method of claim 1, further comprising:
displaying, with the graphical user interface, dependencies between the mandatory service elements of the configuration of the designed IT service using directed connections between the graphical representations of the mandatory service elements in the service element view.

3. The method of claim 1, further comprising:
displaying, with the graphical user interface, optional service elements compatible with the at least one service product; and
interactively adding, with the graphical user interface, at least one of the displayed optional service elements to the designed IT service by adding it to the service element view;
wherein, during outputting, information about the at least one added optional service element is included in the configuration of the designed IT service.

4. The method of claim 3, wherein the optional service element is added interactively using a drag-and-drop mechanism of the graphical user interface.

5. The method according to claim 3, further comprising:
adding at least one dependent service element of the at least one optional service product to a configuration of the designed IT service based on the set of service element dependencies stored in the service element database;
wherein, during displaying, a graphical representations of the at least one added dependent service elements is displayed in the service element view; and
during outputting, information about the at least one added dependent service element is included in configuration of the designed IT service.

6. The method of claim 1, further comprising:
displaying, with the graphical user interface, further service elements contained in the service element database;
interactively adding, with the graphical user interface, at least one of the displayed further service elements to the designed IT service by adding it to the service element view;
wherein, during outputting, information about the at least one added further service element is included in configuration of the designed IT service.

7. The method of claim 1, further comprising:
interactively removing, with the graphical user interface, at least one of the displayed service elements from the designed IT service by deleting a corresponding graphical representation in the service element view;
wherein, during outputting, information about the at least one removed service element is excluded from the configuration of the designed IT service.

8. The method according to claim 7, further comprising:
displaying, with the graphical user interface, a warning message if the service elements included in the configuration does not comply with service element dependencies stored in the service element database.

9. The method of claim 1, further comprising:
displaying, with the graphical user interface, tools available for the implementation of configuration of the designed IT service in a tool view, wherein the available tools are determined based on a set of service tool availabilities stored in a tool database; and
selecting at least one of the available tools for an implementation of at least one service element in the tool view;
wherein, during outputting, information about the at least one selected tool is included in configuration of the designed IT service.

10. The method of claim 9, further comprising:
displaying, with the graphical interface, tool interfaces and compatibility based on additional information stored in the tool database.

11. The method of claim 1, further comprising:
displaying, with the graphical user interface, delivery units available for the implementation of at least one service element of the configuration using a delivery unit view, wherein available delivery units are determined based on a set of service delivery unit responsibilities stored in a delivery unit database; and
selecting at least one of the available delivery units for the at least one service element using the delivery unit view;
wherein, during outputting, information about the at least one selected delivery unit is included in configuration of the designed IT service.

12. The method of claim 11, further comprising.
displaying, with the graphical user interface, organization and cooperation information concerning the selected delivery unit based on additional information stored in the delivery unit database.

13. The method of claim 1, further comprising:
displaying, with the graphical user interface, roles and skills required for implementation of at least one service element of configuration using a roles and skills view, wherein roles and skills are determined based on a set of roles and skills requirements stored in a roles and skills database.

14. The method of claim 1, further comprising:
determining a predicted level of standardization of configurations of the designed IT service with respect to a default configuration provided for the selected service product; and
displaying, with the graphical interface, a predicted level of standardization.

15. The method of claim 14, wherein, during displaying the predicted level of standardization, color of a display element of the graphical user interface used to display the predicted level of standardization is changed based on an amount of predicted level of compliance.

16. An IT service design system, comprising:
a display that displays a graphical user interface;
a storage device that stores a service element database comprising a set of service element dependencies; and
a processor that processes a method for designing IT services, the method comprising:
selecting, with the graphical user interface, at least one service product to be provided by the designed IT service;
adding mandatory service elements for the at least one service product to a configuration of the designed IT serviced automatically based on a set of service element dependencies stored in the service element database;
displaying, with the graphical user interface, a graphical representation of added mandatory service elements in a service element view; and
outputting the configuration of the designed IT service comprising information about the added mandatory service elements.

17. The IT service design system of claim 16, wherein the display comprises a client computer comprising a web browser.

18. The IT service design system of claim 16, wherein the storage device is provided by a database server computer.

19. The IT service design system of claim 16, wherein the processor is provided by an application server computer.

20. A computer readable storage medium comprising program code that performs a method for designing IT services when the program code is executed by a processing unit of a computing device comprising:
selecting, with a graphical user interface, at least one service product to be provided by a designed IT service;
adding mandatory service elements for the at least one service product to a configuration of the designed IT service automatically based on a set of service element dependencies stored in a service element database;
displaying, with the graphical user interface, a graphical representation of the added mandatory service elements in a service element view; and
outputting the configuration of the designed IT service comprising information about the added mandatory service elements.
